(19) United States
(12) Patent Application Publication
(10) Pub. No.: US 2024/0403978 A1
(43) Pub. Date: Dec. 5, 2024

(54) Distributed Water Resource Allocation Method and System for Overall Planning and Coordination

(71) Applicant: Mingzhi Yang, Beijing City (CN)

(72) Inventor: Mingzhi Yang, Beijing City (CN)

(21) Appl. No.: 18/664,696

(22) Filed: May 15, 2024

(30) Foreign Application Priority Data
May 24, 2023 (CN) 202310586394.2

(51) Int. Cl. G06Q 50/06; G06Q 10/0631

(52) U.S. Cl. CPC G06Q 50/06; G06Q 10/06315

(57) ABSTRACT

A distributed water resource allocation method and which includes: acquiring a sub-basin in a setting region based on data of a digital elevation model, and dividing the sub-basin into a plurality of allocation units by applying a multi-attribute overlaying method; determining a spatial topological relationship between water users and water sources in the various allocation units according to a water supply priority of the water source and a water use priority of the water user; acquiring water demand data in an administrative region, and calculating a water supply amount of each water source as well as a daily amount of water allocation, water consumption, water discharge and pollutant discharge of each water user in the administrative region; constructing objective functions and constraint conditions; and resolving the objective functions based on the constraint conditions and by adopting a genetic algorithm, to obtain water resource allocation data.

### CROSS REFERENCE TO RELATED APPLICATION

This application claims the benefit of and takes priority from Chinese Patent Application No. 202310586394.2 filed on May 24, 2023, the contents of which are herein incorporated by reference.

### TECHNICAL FIELD

The present disclosure relates to the field of coupling calculation for a hydrological model and a water resource optimal allocation model, and in particular to a distributed water resource allocation method and system for overall planning and coordination.

### BACKGROUND

Taking a natural-artificial water cycle as a link, a water-social economy-environment system is a complex system formed by associating with human production activities, water resources, environment. The socio-economic subsystems, water subsystems and environment subsystems interrelate and affect each other, to constitute a restrictive relationship based on a competition of limited water resources. Human production activities have enlarged the utilization of water resources, and meanwhile discharging a great number of wastewater and sewage has changed evolvement rules of a water cycle and an associated process, destroyed the original water cycle equilibrium state and caused water environment deterioration, which will ultimately restrict the socio-economic development of the region in turn. The environment deterioration also forces human to reduce the water intake and consumption and pollutant discharge quantity, to improve the water quality of rivers and lakes and recover the equilibrium state of the water cycle system. Reasonable water resource allocation has become an effective strategy to solve the regional water safety issue, coordinate the complex relationship among the socio-economic subsystems, water subsystems and environment subsystems, and seek to make them generate an active linkage. Therefore, carrying out a research on the water resource optimal allocation based on a water-social economy-environment overall planning and coordination relationship, including the linkage relationship among the socio-economic subsystems, water subsystems and environment subsystems into a decision-making process and solving barriers and bottlenecks for the coordinated development of the compound system such as a worsened contradiction between supply and demand of water resources due to improper planning and management and increasing environmental pollution are core issues to be urgently solved in the field of water resource allocation.

The water resource allocation is an important method to implement the fair water resource, and guarantee the sustainable development of the social economy and the ecological environment. Throughout the development history of the water resource allocation, the research on the water resource allocation at home and abroad is inseparable from the coordinated development of human and nature. Zuo Qiting, et al. (2003) proposed a quantitative water resource management model for the sustainable development; Liu Honghong, et al. (2014) proposed a game model for reasonable basin water resource allocation based on an ant colony algorithm, to explore an effective scheme for a water conflict in a process of solving the water resource allocation in the Heihe River basin; and Li Shenlin, et al. (2017) introduced the ruin theory into the research on the reasonable water resource allocation, optimized and improved the theory, and applied the theory to the competitive water resource allocation in cities along the Dongjiang River basin of Guangdong province. Although this kind of water resource allocation method can meet and respect the actual water consumption situation, take into account the water allocation fairness and high efficiency, and guarantee basic water demands and other principles, the allocation target focuses on the overall effect for the optimization of the region/basin water-social economy-environment system, the optimal overall scheme is determined with the base of collective rationality hypothesis and from the single decision-making subject of the administrator, the result of allocation is optimal for the overall benefit of the system, but the concern on the water resource allocation effect of a basic unit is insufficient, so the appeal of the individual benefit of the basic unit is hard to be satisfied, resulting in a poor feasibility during the scheme implementation.

Under the framework for water resource system simulation, a series of representative universal models such as a MIKE BASIN model and a WEAP (Water Evaluation And Planning) model have been developed worldwide, and many Chinese scholars have also proposed a batch of water resource allocation models such as a WROOM model. Most of these universal water resource allocation models belong to lumped allocation models, the spatial difference between physiographic conditions and socio-economic parameters in a calculation zone is neglected in space, and the water resource issue at a specific location is easily neglected. A pattern for monthly allocation is generally adopted in time, which cannot respond to the influence of dynamic changes of a runoff yield and a water quality on the water resource allocation and is difficult to completely describe the dynamic variability of the water resource, and results of dual water supply are prone to the generation of deviations during complex physical and chemical processes such as diffusion, collection, migration and conversion of point source pollutants and non-point source pollutants.

### SUMMARY

The objective of the present disclosure is to provide a distributed water resource allocation method and system for overall planning and coordination, which can coordinate the relationship among the society, economy, ecology and efficiency in a manner of overall planning, such that water resource allocation results are more easily implemented in specific management.

In order to achieve the foregoing objective, the present disclosure adopts the technical solution below:

A distributed water resource allocation method for overall planning and coordination, the allocation method includes:
acquiring a sub-basin in a setting region based on data of a digital elevation model, and dividing the sub-basin into a plurality of allocation units by applying a multi-attribute overlaying method and according to a land use type, a soil type, a slope type, water resource zoning, an administrative region and an irrigation zone;
determining a spatial topological relationship between water users and water sources in the various allocation units according to a water supply priority of the water source and a water use priority of the water user, where the spatial topological relationship is a correspondence between water use types of the water users and water supply types of the water sources, the water use types include urban resident, industry, construction industry, service industry, urban ecological environment, rural resident, livestock breeding, rural ecological environment and agricultural irrigation, and the water supply types include river, reservoir, pond, shallow aquifer, deep aquifer, transferred water, rain collecting pond, water reclamation plants and desalinator;
acquiring water demand data in the administrative region, and calculating a water supply amount of each water source as well as a daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user;
constructing objective functions and constraint conditions based on the daily water supply of each water source as well as the daily amount of water allocation, water consumption, water discharge and pollutant discharge of each water user, where the objective functions are the maximum regional overall planning and coordination degree and the minimum regional pollutant discharge, and the constraint conditions include a water resource quantity constraint, a total water use quantity constraint, a water supply capacity constraint, a water balance constraint, a dual water supply constraint and a non-negative constraint; and
resolving the objective functions based on the constraint conditions and by adopting a genetic algorithm, to obtain water resource allocation data.

Optionally, the multi-attribute overlaying method is a nested allocation units division method.

Optionally, the acquiring the water demand data in the administrative region, and calculating the water supply quantity of each water source as well as the daily amount of water allocation, water consumption, water discharge and pollutant discharge of each water user in the administrative region according to the spatial topological relationship between the water users and the water sources of the allocation unit corresponding to the administrative region, the water supply priority of the water source and the water use priority of the water user specifically includes:
acquiring the data of water demand, water consumption rate, urban point source pollution and rural non-point source pollution in the administrative region, where the water demand data includes a water demand for the urban resident, industry, construction industry, service industry, urban ecological environment, rural resident, livestock breeding, rural ecological environment and agricultural irrigation, the urban point source pollution data includes an urban sewage discharge, an industrial sewage discharge, a sewage treatment rate of a sewage treatment plant, a concentration of a unprocessed sewage and a concentration of a processed sewage, and the rural non-point source pollution data includes a sewage discharge of the rural life, a sewage discharge of the livestock breeding, a pollutant concentration of the rural resident domestic sewage and a pollutant concentration of the livestock breeding sewage;

Determining the daily allocation water and the water demand type of each water user of the allocation unit corresponding to the administrative region as well as the water supply quantity of each water source in the allocation unit corresponding to the administrative region based on the water demand data, the spatial topological relationship, the water supply priority of the water source and the water use priority of the water user, where the water demand type includes a water consumption for the rural resident land, urban resident land and irrigation land;
obtaining a water consumption quantity of each water user based on the daily allocation water quantity and the water consumption rate data of each water user;
obtaining a water discharge quantity of each water user based on the daily allocation water quantity and the water consumption quantity of each water user;
calculating an urban point source pollution discharge in the allocation unit corresponding to the administrative region based on the urban point source pollution data;
calculating a rural non-point source pollution discharge in the allocation unit corresponding to the administrative region based on the rural non-point source pollution data;
obtaining the pollution discharge quantity based on the urban point source pollution discharge and the rural non-point source pollution discharge; and
counting the daily water allocation of each water user, the water supply quantity of each water source, the water consumption of each water user and the water discharge and the pollution discharge of each water user in the allocation unit corresponding to the administrative region, and obtaining the water supply quantity of each water source as well as the daily amount of water allocation, water consumption, water discharge and pollutant discharge of each water user in the administrative region.

Optionally, the determining the daily allocation water and the water demand type of each water user of the allocation unit corresponding to the administrative region as well as the water supply quantity of each water source in the allocation unit corresponding to the administrative region based on the water demand data, the spatial topological relationship, the water supply priority of the water source and the water use priority of the water user specifically includes:
acquiring an urban land area, a rural land area, an agricultural land area, an available water supply and a water use limiting quantity of each water source, and a water intake capacity of a water intake engineering in the administrative region;
obtaining a plurality of urban land allocation units based on the allocation unit with the land use type as the urban land type in the allocation unit corresponding to the administrative region, and obtaining an area of the urban land allocation units based on an urban land area of the urban land allocation units;
obtaining a plurality of rural land allocation units based on the allocation unit with the land use type as the rural land type in the allocation unit corresponding to the administrative region, and obtaining an area of the rural land allocation units based on a rural land area of the rural land allocation units;
obtaining a plurality of agricultural land allocation units based on the allocation unit with the land use type as the agricultural land type in the allocation unit corresponding to the administrative region, and obtaining an area of the agricultural land allocation units based on an agricultural land area of the agricultural land allocation units;
obtaining the urban water demand data of each urban land allocation unit based on a ratio of the area of each urban land allocation unit to the urban land area, where the urban water demand data includes a water demand for the urban resident, industry, construction industry, service industry and urban ecological environment.
obtaining the rural water demand data of each rural land allocation unit based on a ratio of the area of each rural land allocation unit to the rural land area, where the rural water demand data includes a water demand for the rural resident, livestock breeding and rural ecological environment;
obtaining the agricultural water demand data of each agricultural land allocation unit based on a ratio of the area of each agricultural land allocation unit to the agricultural land area, where the agricultural water demand data is a water demand for the agricultural irrigation;
determining a target water user of the allocation unit based on the number and the water use priority of the water user in the allocation unit corresponding to the administrative region;
determining a water demand type and water demand data of the target water user based on the land use type of the allocation unit, where the water demand data is agricultural water demand data, rural water demand data or urban water demand data;
determining a daily water demand of the target water user based on the water demand data of the target water user;
determining the number, water supply type and water supply priority of each water source corresponding to the target water user in the allocation unit corresponding to the administrative region based on the spatial topological relationship, the water supply priority of the water source and the water demand type;
determining a water intake amount of each water source based on the daily water demand of the target water user, the water supply priority of each water source corresponding to the target water user, the available water supply and the water use limiting quantity of each water source, and the water intake capacity of the water intake engineering; and
determining the daily water allocation of the target water user and the water supply quantity of each water source based on the water intake amount of each water source.

Optionally, the objective functions with the maximum regional overall planning and coordination degree are:

$${F}_{obs 1} = max [ C \cdot S \cdot R \cdot ( 1 - D ) ] ,$$

$${s}_{i} = {\sum }_{i = 1}^{I} {\sum }_{j = 1}^{J} {\sum }_{k = 1}^{K} {WU}_{ijk} / {\sum }_{i = 1}^{I} {\sum }_{j = 1}^{J} {\sum }_{k = 1}^{K} {WD}_{ijk} , {r}_{i} = {s}_{i} / {\sum }_{i = 1}^{N} {s}_{i} , C = N \times \sqrt[N]{{\prod }_{i = 1}^{N} {r}_{i}} ,$$

$$S = \frac{1}{N} \times {\sum }_{i = 1}^{N} {s}_{i} , R = \{ \begin{matrix}S & C \geq {C}_{0} \\ S \times \frac{C}{{C}_{0}} & C < {C}_{0}\end{matrix} and D = {\sum }_{i = 1}^{N} \vert {r}_{i} - \frac{1}{N} \vert ;$$

where F_{obs1} is an overall planning and coordination degree value, C is a coordination degree of a regional water use system, S is a regional water demand satisfaction, R is a water allocation reasonable degree, D is a difference index of a water demand satisfaction degree, Nis a number of the total allocation units, WUᵢⱼₖ is a water consumption of the j^{th} water user of the i^{th} allocation unit in the k^{th} day; WDᵢⱼₖ is a water demand of the j^{th} water user of the i^{th} allocation unit in the k^{th} day, s is a satisfaction degree of the actual water consumption of the i^{th} allocation unit in relative to itself water demand; rᵢ is a ratio of the water use satisfaction degree of the i^{th} allocation unit to the water use satisfaction degree of the whole basin system, and C₀ is a coordination standard;
the objective function with the minimum regional pollutant discharge is:

$${F}_{obs 2} = min {\sum }_{i = 1}^{I} {\sum }_{j = 1}^{J} {\sum }_{k = 1}^{K} ( {PT}_{ijk} + {NPT}_{ijk} ) ;$$

where F_{obs2} is a total regional pollutant discharge quantity, PTᵢⱼₖ is a discharge quantity of the j^{th} pollutant of the i^{th} allocation unit in the k^{th} day, I is a total number of the allocation units, J is a total number of the pollutants, K is a total number of days, and N is a number of the total configuration units.

Optionally, the water resource quantity constraint is

$${\sum }_{i = 1}^{9} {WU}_{i} \leq {\sum }_{i = 1}^{3} ( {WS}_{i} \cdot {a}_{i} ) , {η}_{Irr , 0} \leq {η}_{Irr} < 1 and 0 < {θ}_{pipe} \leq {θ}_{pipe , 0} ,$$

the total water use quantity constraint is WU≤min (WUₐᵢₘ, Wᵤₜ) the water supply capacity constraint is W_{supply}=min (Wᵤₜ, W_{cap}), W_{dead}(i)≤V(i)≤V_{MX}(i); Q(i,j,k)≤Q_{MX}(i), where WUₐᵢₘ is a total annual water consumption target, WU₁ is an urban domestic water consumption, WU₂ is an industrial water consumption, WU₃ is a water consumption for the construction industry, WU₄ is a water consumption for the service industry, WU₅ is a water consumption for the urban ecological environment, WU₆ is a rural domestic water consumption, WU₇ is a water consumption for the livestock breeding, WU₈ is a water consumption for the rural ecological environment, WU₉ is an agricultural irrigation water consumption, WS₁ is an available water for regional storage, WS₂ is a precipitation, WS₃ is transferred water, αᵢ is an effective utilization ratio of the WSᵢ water source, η_{Irr,0} is an effective utilization coefficient of the current irrigation water, θ_{pipe,0} is a current pipeline water loss, WU is a total annual water consumption of the region, Wᵤₜ is an annual available water resource of the region, W_{supply} is an available water supply quantity, W_{cap} is an engineering water supply capacity, W_{dead}(i) is a dead storage of a reservoir i, V(i) is a time period storage of the reservoir i, V_{MX}(i) is a maximum storage of the reservoir i, Q(i,j,k) is a water supply quantity supplied to the water user k by the water supply engineering i on the j^{th} day, Q_{MX}(i) is a maximum water diversion/lifting capacity of the water supply engineering i, η_{Irr} is an effective utilization coefficient of the irrigation water, and θₚᵢₚₑ is a pipeline water loss;

The water balance constraint includes the water balance constraint of the allocation unit and the water balance constraint of the water source, where the water balance constraint of the allocation unit is:

$$WF ( i , j , k ) = WD ( i , j , k ) - {WU}_{out} ( i , j , k ) - {WU}_{res} ( i , j , k ) - {WU}_{rch} ( i , j , k ) - {WU}_{shal} ( i , j , k ) - {WU}_{deep} ( i , j , k ) - {WU}_{pnd} ( i , j , k ) - {WU}_{tank} ( i , j , k ) - {WU}_{salt} ( i , j , k ) - {WU}_{re} ( i , j , k ) ;$$

The water balance constraint of the water source is:

$$V ( i , j + 1 ) = V ( i , j ) + {W}_{p} ( i , j ) - {W}_{in} ( i , j ) - {W}_{out} ( i , j ) - WSP ( i , j ) - {W}_{ET} ( i , j ) - {W}_{f} ( i , j ) ;$$

The dual water supply constraint is c(k,m)≤min [cu(k),cs(m)];
where WF(i,j,k) is a water shortage of the k^{th} water user of the j^{th} allocation unit on the i^{th} day, WD(i,j,k) is a water demand of the k^{th} water user of the j^{th} allocation unit on the i^{th} day, WUₒᵤₜ(i,j,k) is a transferred water supply of the k^{th} water user of the j^{th} allocation unit on the i^{th} day, WUᵣₑₛ(i,j,k) is a reservoir water supply of the k^{th} water user of the j^{th} allocation unit on the i^{th} day, WU_{rch}(i,j,k) is a river water supply of the k^{th} water user of the j^{th} allocation unit on the i^{th} day, WUₛₕₐₗ(i,j,k) is a shallow groundwater supply of the k^{th} water user of the j^{th} allocation unit on the i^{th} day, WU_{deep}(i,j,k) is a deep groundwater supply of the k^{th} water user of the j^{th} allocation unit on the i^{th} day, WU_{pnd}(i,j,k) is a pond water supply of the k^{th} water user of the j^{th} allocation unit on the i^{th} day, WUₜₐₙₖ(i,j,k) is a rain collecting pond water supply of the k^{th} water user of the j^{th} allocation unit on the i^{th} day, WUₛₐₗₜ(i,j,k) is a desalination water supply of the k^{th} water user of the j^{th} allocation unit on the i^{th} day, WUᵣₑ(i,j,k) is a reuse water supply of the k^{th} water user of the j^{th} allocation unit on the i^{th} day, V (i,j+1) is a water storage amount of the river/reservoir/pond i on the (j+1)^{th} day, V(i,j) is a water storage amount of the river/reservoir/pond i on the j^{th} day, Wₚ(i,j) is a precipitation of the river/reservoir/pond i on the j^{th} day, Wᵢₙ(i,j) is an upstream inflow of the river/reservoir/pond i on the j^{th} day, Wₒᵤₜ(i,j) is an outflow of the river/reservoir/pond i on the j^{th} day, WSP(i,j) is a water supply of the river/reservoir/pond i on the j^{th} day, W_{ET}(i,j) is a water surface evaporation of the river/reservoir/pond i on the j^{th} day, Wⱼ(i,j) is a leakage quantity of the river/reservoir/pond i on the j^{th} day, c(k,m) is a water supply concentration supplied to the water user k by the water source m, cu(k) is a maximum water amount concentration capable of being accepted by the water user k, and cs(m) is a target water amount concentration of the water source m.

A distributed water resource allocation system for overall planning and coordination, which is applied in the above-mentioned distributed water resource allocation method for overall planning and coordination, and the allocation system includes:
a unit dividing module, which is configured to acquire a sub-basin in a setting region based on data of a digital elevation model, and to divide the sub-basin into a plurality of allocation units by applying a multi-attribute overlaying method and according to a land use type, a soil type, a slope type, water resource zoning, an administrative region and an irrigation area;
a spatial topological module, which is configured to determine a spatial topological relationship between water users and water sources in the various allocation units according to a water supply priority of the water source and a water use priority of the water user, where the spatial topological relationship is a correspondence between a water use type of the water users and a water supply type of the water sources, the water use type includes urban resident, industry, construction industry, service industry, urban ecological environment, rural resident, livestock breeding, rural ecological environment and agricultural irrigation, and the water supply type includes river, reservoir, pond, shallow aquifer, deep aquifer, transferred water, rain collecting pond, water reclamation plants and desalinator;
a calculation module, which is configured to acquire water demand data in the administrative region, and to calculate a water supply quantity of each water source as well as a daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user;
a construction module, which is configured to construct objective functions and constraint conditions based on the daily water supply of each water source as well as the daily amount of water allocation, water consumption, water discharge and pollutant discharge of each water user, where the objective functions are the maximum regional overall planning and coordination degree and the minimum regional pollutant discharge, and the constraint conditions include a water resource quantity constraint, a total water use quantity constraint, a water supply capacity constraint, a water balance constraint, a dual water supply constraint and a non-negative constraint; and
a resolving module, which is configured to resolve the objective functions based on the constraint conditions and by adopting a genetic algorithm, to obtain water resource allocation data.

According to the specific embodiments provided by the present disclosure, the present disclosure has obtained the following technical effects:

The present disclosure provides a distributed water resource allocation method and system for overall planning and coordination, a water resource allocation model is constructed by adopting a hydrological cycle-water resource allocation bidirectional coupling method, and advantages of allocation simulation and allocation optimization are summarized. By improving the distributed hydrological model and designing and embedding the water resource allocation module and the optimization module and according to “Cask Effect Theory” and “the theorem of maximal probability multiplication”, the objective function is set as the coordination degree, water demand satisfaction, water allocation reasonable degree and water demand satisfaction degree difference of the basin water system, and the distributed water resource optimal allocation model for overall planning and coordination is constructed, making the model have the functions such as simulation for the distributed water resource system and optimal allocation for the water resource. A dynamic mutual feed relationship between the natural water cycle and the social water cycle is fully considered during the water resource allocation, and when optimizing the solution, a coordination relationship among the society, economy, ecology and efficiency is taken into full account, such that the water resource allocation solution is more easily implemented to the specific management, to facilitate the coordinated and ordered development of the water resource-social economy-environmental system.

### BRIEF DESCRIPTION OF THE DRAWINGS

To better clarify the embodiments of the present disclosure or the technical solution in the prior art, the drawings required to illustrate the embodiments will be simply described below. It is apparent that the drawings described below merely illustrate some embodiments of the present disclosure. Those of ordinary skill in the art can obtain other drawings without contributing creative labor on the basis of those drawings.

FIG. 1 is a flowchart of a distributed water resource allocation method for overall planning and coordination in the present disclosure.

FIG. 2 is a flowchart for allocation and calculation in the present disclosure.

FIG. 3 is a process comparison diagram of actually measured and simulated monthly runoff in embodiments of the present disclosure.

FIG. 4 is a comparison diagram of a measured value and a simulated value of ammonia nitrogen in embodiments of the present disclosure.

FIG. 5 is a comparison diagram of a measured value and a simulated value of total phosphorus in embodiments of the present disclosure.

FIG. 6 is a module diagram of a distributed water resource allocation system for overall planning and coordination in the present disclosure.

### REFERENCE SIGNS

unit dividing module—1, spatial topological module—2, calculation module—3, construction module—4, resolving module—5.

### DETAILED DESCRIPTION OF THE EMBODIMENTS

The technical solution in the embodiments of the present disclosure is clearly and completely elaborated below in combination with the drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

The objective of the present disclosure is to provide a distributed water resource allocation method and system for overall planning and coordination, which can fully consider the coordination relationship among the society, economy, ecology and efficiency, such that the water resource allocation solution is more easily implemented in specific management.

The overall planning and coordination of the water resource allocation is to reflect the overall condition of the satisfaction degree of socio-economic water and ecological environment water in each calculation unit of the region, representing a rationality degree of the water resource allocation of each subsystem such as the society, economy, ecology and environment. According to “Cask Effect Theory” and “the theorem of maximal probability multiplication”, the total regional water resource is a total length of a board, whether or not the water for the economic and social system and the ecological environment system in the region is coordinated is restricted by numerous factors, and the development status of a certain subsystem depends on the worst status of the water allocation of the subsystem in each subarea under the same conditions. Therefore, the coordination objective function of the water resource allocation model should adopt indicative evaluation indexes such as the coordination degree, water demand satisfaction, water allocation reasonable degree and water demand satisfaction degree difference of the basin water system.

In order to make the above purposes, features and advantages of the present disclosure more obvious and understandable, the present disclosure will be further described in detail below in combination with the drawings and specific implementations.

### Embodiment I

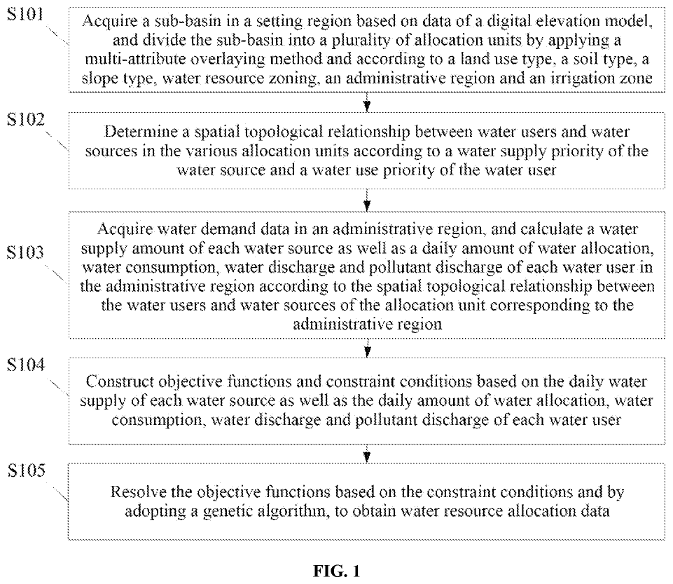

As shown in FIG. 1, the present disclosure provides a distributed water resource allocation method for overall planning and coordination, and the allocation method includes:

S101: Acquiring a sub-basin in a setting region based on data of a digital elevation model, and dividing the sub-basin into a plurality of allocation units by applying a multi-attribute overlaying method and according to a land use type, a soil type, a slope type, water resource zoning, an administrative region and an irrigation zone. Specifically, the multi-attribute overlaying method is a nested allocation units division method, and performing the division of the calculation unit by adopting the nested allocation units division method includes division of natural sub-basin, division of HRU (Hydrological Response Unit), overlaying of the water resource zoning, overlaying of the administrative region and overlaying of the irrigation area.

Further, the “Hydrology” function of Arc Hydro Tools in ArcGIS is adopted for the division of the natural sub-basin, the requirement for generating the critical threshold of the sub-basin catchment area is set, a basin divide is identified, and a scope of a natural sub-basin is determined; the “Overlay” function of Arc Hydro Tools is adopted for the division of the hydrological calculation unit, and the land use type, soil type and slope type in the sub-basin are overlaid, to divide a plurality of HRUs; the “Editor Toolbar” function of ArcGIS is adopted for the overlaying of the water resource zoning, the boundary GIS (Geographic Information System) map of the water resource zoning is directly overlaid on a HRUGIS map divided previously, HRU is divided into two to form irregular units I, and attributes of the water resource zoning are attached to the divided irregular units I; the “Editor Toolbar” function of ArcGIS is adopted for the overlapping of the administrative region, the boundary GIS map of the county-level administrative region is directly overlaid to the GIS map of the previously divided irregular units I, and the attributes of the administrative region are attached, to form irregular units II; and the “Editor Toolbar” function of ArcGIS is adopted for the overlapping of the irrigation zone, the boundary GIS map of the irrigation zone is directly overlaid on the GIS map of the previously divided irregular units II, the attributes of the irrigation zone are attached, and finally the division of the allocation unit is completed.

This dividing method for the allocation unit facilitates the daily transfer of the allocation result and the implementation of the bidirectional coupling for the water resource allocation model and the distributed hydrological model. The type of the water user in the calculation unit depends on the land use type of the allocation unit; if the land use type of the allocation unit is the urban land, the corresponding calculation unit water user includes the urban resident, industry, construction industry, service industry, urban ecological environment; if the land use type of the allocation unit is the rural land, the corresponding calculation unit water user includes the rural resident, livestock breeding, rural ecological environment; and if the land use type of the allocation unit is the agricultural land, the corresponding calculation unit water user includes irrigation farmland, irrigation forest, irrigation grassland.

S102: Determining a spatial topological relationship between water users and water sources in the various allocation units according to a water supply priority of the water source and a water use priority of the water user, where the spatial topological relationship is a correspondence between water use types of the water users and water supply types of the water sources. Specifically, a one-to-multi or multi-to-one “point and line to plane” spatial topological relationship between each water user and each water source in the allocation unit is constructed by adopting a document reading information input mode, to achieve a connection between the water source and the water user. The water user includes 9 types such as the urban resident, industry, construction industry, service industry, urban ecological environment, rural resident, livestock breeding, rural ecological environment and agricultural irrigation, and the water source type includes 9 water source types such as the river, reservoir, pond, shallow aquifer, deep aquifer, transferred water, rain collecting pond, water reclamation plants and desalinator. The same water user may be connected with a plurality of water sources, and the same water source may also be connected with a plurality water users or a plurality of allocation units. The water supply priority of the water source and the water use priority order in the allocation unit are set, and an accurate simulation of the water resource in the allocation system is achieved by establishing an allocation relationship between the water source and the water user.

S103: Acquiring water demand data, water consumption rate data and pollutant discharge concentration data in the administrative region by adopting the document reading information input mode, and performing a day-by-day and unit-by-unit calculation according to the correspondence between each water user and each water source type, the water supply priority of each water source, the water use priority order of each water user and the water demand data, to obtain the water supply quantity of each water source, as well as the daily water demand, water consumption, water discharge and pollution discharge of each water user. S103 specifically includes:

S1031: Reading the input water demand data document, acquiring the data of water demand, water consumption rate, urban point source pollution and rural non-point source pollution in the administrative region, where the water demand data includes a water demand for the urban resident, industry, construction industry, service industry, urban ecological environment, rural resident, livestock breeding, rural ecological environment and agricultural irrigation, the urban point source pollution data includes an urban sewage discharge, an industrial sewage discharge, a sewage treatment rate of a sewage treatment plant, a concentration of a unprocessed sewage and a concentration of a processed sewage, and the rural non-point source pollution data includes a sewage discharge of the rural life, a sewage discharge of the livestock breeding, a pollutant concentration of the rural resident domestic sewage and a pollutant concentration of the livestock breeding sewage.

S1032: Determining the daily allocation water and the water demand type of each water user of the allocation unit corresponding to the administrative region as well as the water supply quantity of each water source in the allocation unit corresponding to the administrative region based on the water demand data, the spatial topological relationship, the water supply priority of the water source and the water use priority of the water user, where the water demand type includes a water consumption for the rural resident land, urban resident land and irrigation land. S1032 specifically includes:

S103201: Acquiring an urban land area, a rural land area, an agricultural land area, an available water supply and a water use limiting quantity of each water source, and a water intake capacity of a water intake engineering in the administrative region. Specifically, the total area of the urban, rural and agricultural land in the county-level administrative region is counted based on the area of each allocation unit and obtained upon calculation. Based on the dividing process of the allocation units, the area of each allocation unit is directly acquired after ArcGIS is adopted for dividing.

S103202: Obtaining a plurality of urban land allocation units based on the allocation unit with the land use type as the urban land type in the allocation unit corresponding to the administrative region, and obtaining an area of the urban land allocation units based on an urban land area of the urban land allocation units.

S103203: Obtaining a plurality of rural land allocation units based on the allocation unit with the land use type as the rural land type in the allocation unit corresponding to the administrative region, and obtaining an area of the rural land allocation units based on a rural land area of the rural land allocation units.

S103204: Obtaining a plurality of agricultural land allocation units based on the allocation unit with the land use type as the agricultural land type in the allocation unit corresponding to the administrative region, and obtaining an area of the agricultural land allocation units based on an agricultural land area of the agricultural land allocation units.

S103205: Obtaining the urban water demand data of each urban land allocation unit based on a ratio of the area of each urban land allocation unit to the urban land area, where the urban water demand data includes a water demand for the urban resident, industry, construction industry, service industry and urban ecological environment.

S103206: Obtaining the rural water demand data of each rural land allocation unit based on a ratio of the area of each rural land allocation unit to the rural land area, where the rural water demand data includes a water demand for the rural resident, livestock breeding and rural ecological environment.

S103207: Obtaining the agricultural water demand data of each agricultural land allocation unit based on a ratio of the area of each agricultural land allocation unit to the agricultural land area, where the agricultural water demand data is a water demand for the agricultural irrigation.

S103208: Determining a target water user of the allocation unit based on the number and the water use priority of the water user in the allocation unit corresponding to the administrative region.

S103209: Determining a water demand type and water demand data of the target water user based on the land use type of the allocation unit, where the water demand data is agricultural water demand data, rural water demand data or urban water demand data.

S103210: Determining a daily water demand of the target water user based on the water demand data of the target water user.

S103211: Determining the number, water supply type and water supply priority of each water source corresponding to the target water user in the allocation unit corresponding to the administrative region based on the spatial topological relationship, the water supply priority of the water source and the water demand type.

S103212: Determining a water intake amount of each water source based on the daily water demand of the target water user, the water supply priority of each water source corresponding to the target water user, the available water supply and the water use limiting quantity of each water source, and the water intake capacity of the water intake engineering.

S103213: Determining the daily water allocation of the target water user and the water supply quantity of each water source based on the water intake amount of each water source.

S1033: Obtaining a water consumption of each water user based on the daily allocation water and the water consumption rate data of each water user.

S1034: Obtaining a water discharge quantity of each water user based on the daily allocation water and the water consumption of each water user.

S1035: Calculating an urban point source pollution discharge in the allocation unit corresponding to the administrative region based on the urban point source pollution data.

S1036: Calculating a rural non-point source pollution discharge in the allocation unit corresponding to the administrative region based on the rural non-point source pollution data. S1037: Obtaining the pollution discharge quantity based on the urban point source pollution discharge and the rural non-point source pollution discharge.

S1038: Counting the daily water allocation of each water user, the water supply of each water source, the water consumption of each water user and the water discharge and the pollution discharge of each water user in the allocation unit corresponding to the administrative region, and obtaining the water supply quantity of each water source, as well as the daily amount of water allocation, water consumption, water discharge and pollutant discharge of each water user in the administrative region.

S104: Constructing objective functions and constraint conditions based on the daily water supply of each water source as well as the daily amount of water allocation, water consumption, water discharge and pollutant discharge of each water user, where the objective function are the maximum regional overall planning and coordination degree and the minimum regional pollutant discharge, and the constraint conditions include a water resource quantity constraint, a total water use quantity constraint, a water supply capacity constraint, a water balance constraint, a dual water supply constraint and a non-negative constraint.

S105: Resolving the objective functions based on the constraint conditions and by adopting a genetic algorithm, to obtain water resource allocation data.

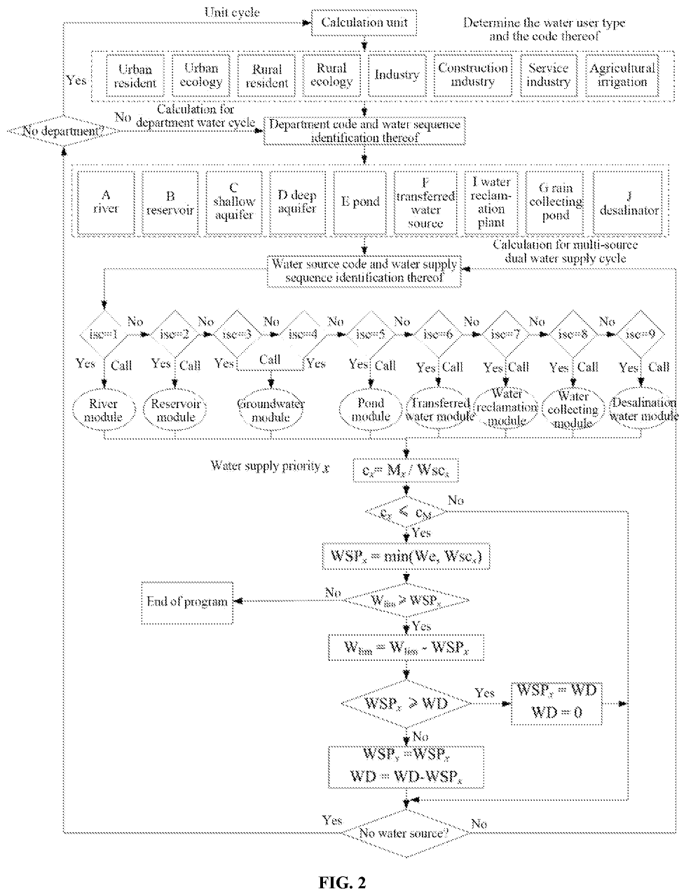

In an actual application, S103 is the design for the water resource allocation module that serves as a built-in module of the distributed hydrological model and is driven by the hydrological model, the calculation for the water resource allocation includes distribution for water demand data as well as calculation for, water intake, water use, water consumption and discharge, and the spatial distribution is carried out by inputting water demand data information; the information is transmitted to a water intake module, then the water intake module analyzes and calculates the water intake quantity of each water source, the water source includes 9 types of water sources such as river water, reservoir water, shallow groundwater, deep groundwater, pond water, transferred water, rainwater, reuse water and desalination water, the information is transmitted to each water source module of the hydrological model to calculate the water supply quantity of each water supply source, the water is allocated to each water user in each allocation unit, and then the quantity of water consumption, water discharge and pollutant discharge are sequentially calculated; and finally the data is transmitted back to the hydrological model to perform the simulation of the water quantity and quality process, thereby achieving the dynamic mutual feed calculation of the distributed hydrological model and the water resource allocation module and laying a foundation for the optimal allocation. The specific implementation method includes a spatial distribution design, an allocation calculation design, a water consumption and discharge calculation and a pollutant discharge calculation.
(1) The spatial distribution design specifically includes: reading the input water demand data document and performing the water demand data input with the unit of the county-level administrative region, and the data includes a water demand for the urban resident, industry, construction industry, service industry, urban ecological environment, rural resident, livestock breeding, rural ecological environment and agricultural irrigation, etc. The data is decomposed and distributed to the calculation unit based on the distribution and area of the urban land, rural land and irrigation land in the county-level administrative region, and steps for the spatial distribution are as follows:
Step I: After the water demand data information in the county-level administrative region is read in, searching the allocation unit belonging to the administrative region, counting the total area of the urban, rural and agricultural land in the county-level administrative region, and separately calculating a proportion of the allocation unit of each urban land type accounting for the total area of the urban land in the county-level administrative region, a proportion of the allocation unit of the rural land type accounting for the total area of the rural land in the county-level administrative region and a proportion of the allocation unit of the irrigation land type accounting for the total area of the irrigation land in the county-level administrative region. The total area of the urban, rural and agricultural land in the county-level administrative region is counted based on the area of each allocation unit and obtained upon calculation. Based on the dividing process of the allocation units, the area of each allocation unit is directly acquired after ArcGIS is adopted for dividing.
Step II: Based on the proportion of the allocation unit area accounting for the total area of the county-level administrative region, allocating the data of the water demand for the rural resident, livestock breeding and rural ecological environment to the rural resident land, allocating the water demand for the urban resident, industry, construction industry, service industry and urban ecological environment to the urban resident land, and allocating the water demand for the agricultural irrigation to the irrigation land.
(2) The design for allocation and calculation specifically includes: determining the water use priority, the type and number of the water supply source and a the water supply priority of each water user in the allocation unit based on the spatial topological relationship between the previously established water source and the water user and the water supply priority, seeking each water source for water intake in turn until the daily water demand of the water user is satisfied or the water supply for the last water supply source is finished, and as shown in FIG. 2, steps for the water supply calculation are as follows:
Step I: Determining the number and water use priority of the water user in the allocation unit, and defining the target water user.
Step II: Defining the daily water demand WD of the target water user.
Step III: Defining the water supply source number t, water source identification code and water supply priority of the target water user, and calling each water source module. Where t≤A+B+C+D+E+F+G+I+J (A, B, C, D, E, F, G, I and J represent the water source number of 9 types such as the river, reservoir, pond, shallow aquifer, deep aquifer, transferred water, rain collecting pond, water reclamation plants and desalinator in respective); and the water source identification code isc of the respective water source is sequentially read according to the water supply priority of 1 to t (t=A+B+C+D+E+F+G+I+J). When the water source identification code isc is 1, 2, 3, 4, 5, 6, 7, 8 and 9, a river module, a reservoir module, a shallow groundwater module, a deep groundwater module, a water transfer module, a pond module, a reuse water module, a rain collecting module and a desalination water module are called in respective. When building the spatial topological relationship, the document reading information input mode is adopted to input the type and number of the water supply source as well as the water supply priority and maximum water quality allowable concentration thereof of each allocation unit.
Step IV: Identifying whether or not the water quality concentration reaches the standard, calculating the water quality concentration cₓ=Mₓ/Wscₓ of the water source based on a pollutant load capacity Mₓ and a total water source Wscₓ (x represents the water supply priority of the water source) of the water source after calling the water source module, and identifying whether or not the water quality of the water supply source meets the water intake requirements based on the water quality requirement document of the input water supply source. If meeting the requirement, that is, cx≤c_{M} (maximum water quality allowable concentration), the program will enter the process of the water intake calculation; and if not, the water source of the secondary water supply priority is sought; and if the water supply source is unavailable, the program will enter the next cycle for the allocation unit.
Step V: For the water source with the water supply priority of x (x∈[1, t)), taking water from the water source preferentially, the available water supply of the water source is WSPₓ=min (Wscₓ, We) (Wscₓ and We represent the total water resource of the water source and the water intake capacity of the water intake engineering in respective); if the available water supply of the water source is WSPₓ>Wₗᵢₘ (total water limit in the county-level administrative region), Wₗᵢₘ=Wₗᵢₘ−WSPₓ; if not, representing that the county-level administrative region has reached the water limiting conditions and cannot continue to use water again, and the program exits; if the available water supply of the water source is WSPₓ>WD, the water supply of the water source is WSPₓ=WD, then WD is assigned with a value of 0, and the water supply calculation is over; and if not, WSPₓ=min (Wscₓ, We), the water demand of the water user is reduced to WD=WD−min (Wscₓ, We), the total water limit in the county-level administrative region is reduced to Wₗᵢₘ=Wₗᵢₘ−min (Wscₓ, We), and the program will continue to seek the water source of the secondary water supply priority.
Step VI: For the water source with the water supply priority of t, the available water supply of the water source is WSPₜ=min (Wscₜ, We) (Wscₜ and We represent the total water resource of the water source and the water intake capacity of the water intake engineering in respective); if the available water supply of the water source is WSPₜ>Wₗᵢₘ (total water limit in the county-level administrative region), Wₗᵢₘ=Wₗᵢₘ−WSPₜ; if not, representing that the county-level administrative region has reached the water limiting conditions and cannot continue to use water again, and the program exits; if the available water supply of the water source is WSPₜ>WD, the water supply of the water source is WSPₜ=WD, then WD is assigned with a value of 0, and the water supply calculation is over; and if not, WSPₜ=min (Wscₜ, We,), the water demand of the water user is reduced to WD=WD−min (Wscₜ, We), the total water limit in the county-level administrative region is reduced to Wₗᵢₘ=Wₗᵢₘ−min (Wscₜ, We), and the water supply calculation is over, to enter the water intake calculation cycle of the next water user until all water users in the allocation units are calculated.
(3) The calculation for the water consumption and discharge specifically includes: acquiring the urban and rural domestic water consumption rate, the ecological environment water consumption rate, the industrial water consumption rate, the construction industry water consumption rate, the service industry water consumption rate, the livestock water consumption rate and other data by reading the input water consumption rate data document and upon the calculation for the water consumption and discharge, and separately calculating the water consumption quantity and the water discharge quantity in combination with the daily water consumption of various water users on the allocation units. Calculation formula:

$${WC}_{i} = {WU}_{i} \cdot {f}_{i} \qquad ( 1 )$$

$$and$$

$${WR}_{i} = {WU}_{i} - {WC}_{i} . \qquad ( 2 )$$

Where WCᵢ represents the daily water consumption of the i^{th} water user on the allocation unit, m³/d, WUᵢ represents the daily water consumption of the i^{th} water user (including the urban and rural resident, urban and rural ecology, industry, construction industry, service industry, livestock breeding, agricultural irrigation) on the allocation unit, m³/d; WRᵢ represents the daily water discharge of i^{th} water user on the allocation unit, m³/d; ƒᵢ represents the water consumption rate (including the water consumption rate of the urban and rural resident, the urban and rural ecological environment water consumption rate, the industrial water consumption rate, the construction industry water consumption rate, the service industry water consumption rate, the livestock water consumption rate) of the i^{th} water user on the allocation unit.

$${W}_{aird} = {WU}_{irr} \cdot ( 1 - rto ) \qquad ( 3 )$$

$${W}_{qird} = W {U}_{irr} \cdot rto \qquad ( 4 )$$

Where W_{aird} is an unknown quantity, representing the daily irrigation water consumption on the allocation unit, m³/d; WUᵢᵣᵣ is a known quantity, representing the daily irrigation water consumption on the allocation unit, m³/d; W_{qird} is an unknown quantity, representing the irrigation water discharge on the allocation unit, m³/d; and rto is a known quantity, representing the irrigation runoff producing rate on the allocation unit.
(4) The pollutant discharge calculation specifically includes: separately calculating the urban point source pollution and non-point source pollution. The pollutant mainly includes ammonia nitrogen, nitrate nitrogen, total phosphorus, a biochemical oxygen demand, etc. The urban point source pollution includes the urban domestic pollution and industrial pollution, and the calculation formula may be uniformly represented as:

$$PT = ( {WR}_{urb} + {WR}_{ind} ) \cdot [ ( 1 - a ) \cdot {c}_{1} + a \cdot {c}_{2} ] / 1000 \qquad ( 5 )$$

Where PT is an unknown quantity, representing the urban point source pollution discharge, kg/d; WR_{urb} and WR_{ind} are known quantities, separately representing the urban domestic sewage discharge and industrial sewage discharge, m³/d; a is a known quantity, representing a sewage treatment rate of a sewage treatment plant, and c₁ and c₂ are known quantities, separately representing the pollutant concentrations of the untreated and treated sewage, mg/L. The calculation results of the urban point source pollution are delivered to the point source module of the hydrological model, to carry out the water quality process calculation.

The rural non-point source pollution includes rural domestic pollution, livestock breeding pollution and farmland pollution, with the expression formula as follows:

$$NPT = {WR}_{rur} \cdot {r}_{rur} + {WR}_{an} \cdot {r}_{an} ) / 1000 \qquad ( 6 )$$

Where NPT is an unknown quantity, representing the rural non-point source pollution discharge, kg/d; WRᵣᵤᵣ is a known quantity, representing the rural domestic sewage discharge, m³/d; WRₐₙ is a known quantity, representing the livestock breeding sewage discharge, m³/d; rᵣᵤᵣ and rₐₙ are known quantities, representing the rural resident pollutant concentration and the livestock breeding sewage pollutant concentration in respective, mg/L. The calculation results of the rural non-point source pollution are delivered to the sub-basin module of the hydrological model, to carry out the land pollution process simulation.

In an actual application, a set of operation rules, including the objective functions and the constraint condition are designed for the distributed water resource optimal allocation module at S104. The water supply quantity of each water source is calculated step by step by identifying the water supply source of the allocation unit and according to the water source priority, and the whole allocation system is calculated one by one based on the number sequence of the allocation unit, to meet the requirement of the objective function maximally. The objective function is specifically as follows: (1) objective function 1: maximum regional overall planning and coordination degree.

According to “Cask Effect Theory” and “the theorem of maximal probability multiplication”, whether or not the regional system is optimal is restricted by numerous factors, and the development status of a certain subsystem depends on the worst status of the water allocation of the subsystem in each subarea under the same conditions. Therefore, the model adopts the product of four indexes including the coordination degree, water demand satisfaction, water allocation reasonable degree and water demand satisfaction degree difference of the water system to construct the objective function, with the expression formula as follows:

$${F}_{obs 1} = max [ C \cdot S \cdot R \cdot ( 1 - D ) ] \qquad ( 7 )$$

Where F_{obs1} represents an overall planning and coordination degree value, and C, S, R and D represent a coordination degree, water demand satisfaction, water allocation reasonable degree and water demand satisfaction degree difference of the regional water system in respective. The coordination degree of the water system is used for evaluating the water coordination degree among the allocation units in the region. The calculation formula is as follows:

$${s}_{i} = {\sum }_{i = 1}^{I} {\sum }_{j = 1}^{J} {\sum }_{k = 1}^{K} {WU}_{ijk} / {\sum }_{i = 1}^{I} {\sum }_{j = 1}^{J} {\sum }_{k = 1}^{K} {WD}_{ijk} \qquad ( 8 )$$

$${r}_{í} = {s}_{i} / {\sum }_{i = 1}^{N} {s}_{i} \qquad ( 9 )$$

$$C = N \times \sqrt[N]{{\prod }_{i = 1}^{N} {r}_{i}} \qquad ( 10 )$$

where C (C∈[0,1]) is a coordination degree of the water system, the smaller the C value, the lower the system coordination degree and the worse the comprehensive system status; N is a total number of the allocation unit; WUᵢⱼₖ represents a water consumption quantity of the j^{th} water user of the i^{th} allocation unit on the k^{th} day, m³; WDᵢⱼₖ represents a water demand of the j^{th} water user of the i^{th} allocation unit on the k^{th} day, m³; sᵢ represents a satisfaction degree of the actual water consumption of the i^{th} allocation unit in relative to itself water demand; rᵢ represents a ratio of the water use satisfaction degree of the i^{th} allocation unit to the water use satisfaction degree of the whole basin system, and r₁+r₂+ . . . +r_{N}=1.

The water demand satisfaction represents the degree that itself water demand in the whole region is satisfied after allocated through the water resource.

$$S = \frac{1}{N} \times {\sum }_{i = 1}^{N} {s}_{i} , \qquad ( 11 )$$

where S represents a system water demand satisfaction in the whole region, and sᵢ represents a satisfaction degree of the actual water consumption of the i^{th} allocation unit in relative to itself water demand. The expression formula of the water resource allocation reasonable degree is as follows:

$$R = \{ \begin{matrix}S & C \geq {C}_{0} \\ S \times \frac{C}{{C}_{0}} & C < {C}_{0}\end{matrix} , \qquad ( 12 )$$

where C₀ represents a coordination standard.

The expression formula of the water demand satisfaction degree difference is as follows:

$$D = {\sum }_{i = 1}^{N} \vert {r}_{i} - \frac{1}{N} \vert . \qquad ( 13 )$$

Where D is a difference of each allocation unit in the region to itself water demand satisfaction degree. The greater the D value, the greater the difference, and the lower the coordination of the water allocation among the allocation units.
(2) The objective function 2: the minimum regional pollutant discharge. The greater the water consumption quantity, the higher the pollutant produced, which will reduce the water environment quality, and then affect the use of the water resource. Therefore, the smaller regional pollutant discharge quantity is better. The pollutant evaluation includes ammonia nitrogen, nitrate nitrogen, total phosphorus, a biochemical oxygen demand, etc., and the hydrological model can simulate these pollutants. The expression formula is as follows:

$${F}_{obs 2} = max {\sum }_{i = 1}^{I} {\sum }_{j = 1}^{J} {\sum }_{k = 1}^{K} ( {PT}_{ijk} + {NPT}_{ijk} ) \qquad ( 14 )$$

where F_{obs2} represents a total regional pollutant discharge quantity, kg; PTᵢⱼₖ and NPTᵢⱼₖ represent a discharge quantity of the j^{th} pollutant of the i^{th} allocation unit in the k^{th} day in respective, I represents a number of the total allocation units, J is a total number of the pollutants, and K is a number of simulation days.

In addition, the net regional economic benefit included in the objective function may also be maximized, and the net regional economic benefit is expressed by an accumulated value that the water source water supply is multiplied by the difference between the unit water supply benefit and the water supply cost, with the expression formula as follows:

$${F}_{obs 3} = max {\sum }_{i = 1}^{I} {\sum }_{j = 1}^{J} {\sum }_{k = 1}^{K} {WSP}_{ijk} \cdot ( {eco}_{ijk} - {cost}_{ijk} ) \qquad ( 15 )$$

Where F_{obs3} represents a net regional economic benefit, with a unit of Yuan; WSPᵢⱼₖ represents a water supply quantity to the k^{th} water user from the j^{th} water supply source of the i^{th} allocation unit in respective, with a unit of m³; ecoᵢⱼₖ and costᵢⱼₖ represent a water supply economic benefit and a water supply cost to the k^{th} water user from the j^{th} water supply source of the i^{th} allocation unit in respective, with a unit of Yuan/m³; I represents a number of the total allocation units; J represents a total number of the water supply sources, and K represents a total number of the water users.

The constraint conditions mainly include a water resource quantity constraint, a total water use quantity constraint, a water supply capacity constraint, a water balance constraint, a dual water supply constraint and a non-negative constraint, etc. Specifically as follows: (1) water resource total amount constraint: to ensure the sustainable development of the regional social economy and the ecological environment, the total amount of the basin water resource (calculated according to different departments such as life, industry, agriculture and ecology) cannot exceed the total available amount of the water resource in this region.

$${\sum }_{i = 1}^{9} {WU}_{i} \leq {\sum }_{i = 1}^{3} ( {WS}_{i} \cdot {a}_{i} ) \qquad ( 16 )$$

Where WU represents a total annual water quantity in the region, 10 k m³; WUₐᵢₘ represents a total annual water target, 10 k m³; WU₁, WU₂, WU₃, WU₄, WU₅, WU₆, WU₇, WU₅ and WU₉ represent a water consumption for the urban resident, industry, construction industry, service industry, urban ecological environment, water consumption, livestock breeding, rural ecological environment and agricultural irrigation in respective; WS₁, WS₂ and WS₃ represent an available water quantity (such as a reservoir storage capacity, a river storage capacity, a pond storage capacity, a shallow groundwater storage capacity, a deep groundwater storage capacity), a precipitation and a water transferred quantity in respective, 10 k m³; and αᵢ (C∈[0,1]) is an effective utilization ratio of the WSᵢ water source, which is affected by the social technical level and mainly includes the irrigation water effective utilization coefficient and the pipeline water loss;

$${η}_{Irr , 0} \leq {η}_{Irr} < 1 \qquad ( 17 )$$

$$and$$

$$0 < {θ}_{pipe} \leq {θ}_{pipe , 0} \qquad ( 18 )$$

Where η_{irr,0} represents an effective utilization coefficient of the current irrigation water, θ_{pipe,0} represents a leakage and loss rate of the current pipe network, η_{Irr} is an effective utilization coefficient for the irrigation water, and θₚᵢₚₑ is a pipeline water loss.
(2) Total water use quantity constraint: the total water quantity in the region should be less than the total water use quantity target and the available water resource quantity;

$$WU \leq min ( {WU}_{aim} , {W}_{ut} ) \qquad ( 19 )$$

Where WU represents a total annual water quantity in the region, 10 k m³; WUₐᵢₘ represents a total annual water quantity target, 10 k m³; and Wu represents an annual available water resource quantity in the region, 10 k m³.
(3) Water supply capacity constraint: the regional water supply quantity is limited by the water supply capacity of the engineering. The water supply capacity of the engineering includes a reservoir capacity, a water passing capacity of a water transportation pipeline, a water-carrying capacity of a diversion canal system, a water diversion/lifting capacity, etc. The least value between the available water supply of the available water intake resource and the water supply capacity of the engineering:

$${W}_{supply} = min ( {W}_{ut} , {W}_{cap} ) \qquad ( 20 )$$

Where W_{supply} is an available water supply, 10 k m³; and W_{cap} is a water supply capacity of the engineering, 10 k m³.

$${W}_{dead} ( i ) \leq V ( i ) \leq {V}_{MX} ( i ) and \qquad ( 21 )$$

$$Q ( i , j , k ) \leq {Q}_{MX} ( i ) . \qquad ( 22 )$$

Where W_{dead}(i) represents a dead storage capacity of the reservoir i, m³; V(i) represents a time-period storage capacity of the reservoir i, m³; V_{MX}(i) represents a maximum storage capacity of the reservoir i, m³; Q(i,j,k) represents a water supply to the water user k from the water supply engineering i in the j^{th} day, m³; and Q_{MX}(i) represents a maximum water diversion/lifting capacity of the water supply engineering i, m³.
(4) Water balance constraint: mainly include the water balance constraint of the allocation unit and the water balance constraint of the water source. Where the water balance constraint of the allocation unit is:

$$WF ( i , j , k ) = WD ( i , j , k ) - {WU}_{out} ( i , j , k ) - {WU}_{res} ( i , j , k ) - {WU}_{rch} ( i , j , k ) - {WU}_{shal} ( i , j , k ) - {WU}_{deep} ( i , j , k ) - {WU}_{pnd} ( i , j , k ) - {WU}_{tank} ( i , j , k ) - {WU}_{salt} ( i , j , k ) - {WU}_{re} ( i , j , k ) . \qquad ( 23 )$$

Where WF(i,j,k) represents a water shortage of the k^{th} water user of the j^{th} allocation unit on the i^{th} day, m³; WD represents a water demand, m³; WUₒᵤₜ represents a water supply of the transferred water, m³; WUᵣₑₛ represents a water supply of the reservoir, m³; WU_{rch} represents a water supply of the river, m³; WUₛₕₐₗ represents a water supply of the shallow groundwater, m³; WU_{deep} represents a water supply of the deep groundwater, m³; WU_{pnd} represents a water supply of the pond water, m³; WUₜₐₙₖ represents a water supply of the rain collecting pond, m³; WUₛₐₗₜ represents a water supply of the desalination water, m³; and WUᵣₑ represents a water supply of the reuse water, m³.

Water balance constraint for river/reservoir/pond:

$$V ( i , j + 1 ) = V ( i , j ) + {W}_{p} ( i , j ) - {W}_{in} ( i , j ) - {W}_{out} ( i , j ) - WSP ( i , j ) - {W}_{ET} ( i , j ) - {W}_{f} ( i , j ) . \qquad ( 24 )$$

Where V(i,j) represents a storage capacity of the river/reservoir/pond i on the j^{th} day, m³; Wₚ represents a precipitation, m³; Wᵢₙ represents an upstream inflow, m³; Wₒᵤₜ represents an outflow, m³; WSP represents a water supply, m³; W_{ET} represents a water surface evaporation, m³; and W_{f} represents a leakage quantity, m³.
(5) Dual water supply constraint:

$$c ( k , m ) \leq min [ cu ( k ) , cs ( m ) ] . \qquad ( 25 )$$

Where c(k,m) represents a water quality concentration of the water supply to the water user k from the water source m, mg/L; cu(k) represents a maximum water amount concentration capable of being accepted by the water user k, mg/L; and cs(m) represents a target water amount concentration of the water source m, mg/L.
(6) Non-negative constraint: the variables representing the actual physical meaning in the model cannot be negative, such as the reservoir capacity, the amount of water intake and the water consumption. In an actual application, at S105, an optimization module of the Genetic Algorithm (GA) is adopted and called in a main program module of the distributed water resource optimal allocation model, to process the multi-objective and high-dimension optimization issue. By inputting an enabled instruction of the optimization module, the main program of the model starts to call the optimization module and enters the optimization calculation, with the steps as follows:
(1) Parameter set encoding: the parameter value of the optimization module is initialized, real number encoding is adopted for each chromosome (parameter set), the encoded chromosome is denoted as x; (i=1, 2, . . . , n), and n is the number of decision variables.
(2) Calculation for fitness function: for the objective function ƒ(x) of the water source allocation, if ƒ(x) is to solve the global maximum issue (that is, the objective function 1: the maximum regional overall planning and coordination degree, and objective function 2: the maximum net regional economic benefit), the fitness function may be denoted as:

$$F ( x ) = f ( x ) - {f}_{min} . \qquad ( 26 )$$

Where ƒₘᵢₙ represents a minimum value of ƒ(x), the unknown ƒₘᵢₙ may be represented by a smaller numerical value, and F(x) represents the fitness function. If ƒ(x) is to solve the global minimum issue (that is, the objective function 3: the minimum regional pollutant discharge), the fitness function may be denoted as

$$F ( x ) = {f}_{max} - f ( x ) . \qquad ( 27 )$$

Where ƒₘₐₓ represents a maximum value of ƒ(x), the unknown ƒₘᵢₙ may be represented by a bigger numerical value, and F(x) represents the fitness function.
(3) Gene selection: a roulette algorithm is adopted, and the formula for calculating a probability that each individual x is selected may be expressed as:

$${p}_{x} = [ 1 / F ( x ) ] / [ 1 / {\sum }_{i = 1}^{n} F ( i ) ] \qquad ( 28 )$$

Where pₓ represents a selective probability, and n is the number of the decision variables.
(4) Cross calculation: arithmetic crossing is adopted to perform crossing and variation calculation on parent populations (allocation parameter set), and new progeny populations generate.

$$\{ \begin{matrix}{x}_{1}^{*} = α \cdot {x}_{1} + ( 1 - α ) \cdot {x}_{2} \\ {x}_{2}^{*} = α \cdot {x}_{2} + ( 1 - α ) \cdot {x}_{1}\end{matrix} \qquad ( 29 )$$

Where α represents a random number, α∈(0,1); x₁ and x₂ are parent individuals; and x*₁ and x*₂ represent progeny individuals.
(5) Variation calculation: select the j^{th} gene dᵢⱼ of the i^{th} individual for variation, with the calculation process as follows:

$${d}_{ij} = \{ \begin{matrix}{d}_{ij} + ( {d}_{ij} - {d}_{max} ) \cdot r \cdot {( 1 - t / T )}^{2} & r > 0.5 \\ {d}_{ij} + ( {d}_{min} - {d}_{ij} ) \cdot r \cdot {( 1 - t / T )}^{2} & r \leq 0.5\end{matrix} \qquad ( 30 )$$

Where dₘₐₓ and dₘᵢₙ represent an upper boundary and a lower boundary of dᵢⱼ in respective, r is a random number in [0,1], and t and T represent a current iteration and a maximum iteration in respective.
(6) Calculation for optimal solution: If t is greater than the setting maximum iteration T, the calculation is terminated, and the optimal solution is obtained; and if t is less than T, return to step (3) for the next optimization calculation cycle until to reach the maximum iteration, and the program is over.

As one specific implementation, the design method for the distributed water resource optimal allocation model for overall planning and coordination in the present disclosure mainly includes the following design process:
S1: Dividing the allocation units, adopting an overlapping method to divide the allocation units.
S2: Spatial topological design, constructing a “point and line to plane” spatial topological relationship between each water user and each water source in the allocation unit, to achieve the connection between the water source and the water user.
S3: Allocation calculation design, which includes the distribution for water demand space as well as the calculation for water quantity and quality allocation, water consumption, water discharge and pollution discharge, etc.
S4: Allocation rule design, taking the maximum overall planning and coordination degree, the maximum economic benefit and the minimum pollutant discharge quantity as the objective functions, and taking the water resource quantity constraint, the total water use quantity constraint, the water supply capacity constraint, the water balance constraint as the constraint conditions.
S5: Optimization algorithm design, designing the optimization module, with the target of meeting the objective function maximally, and adopting GA for the parameter optimization calculation.

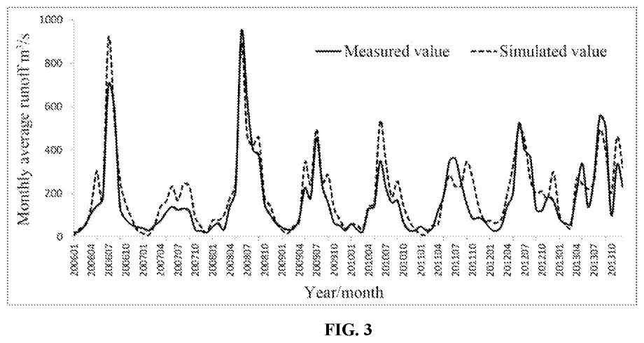

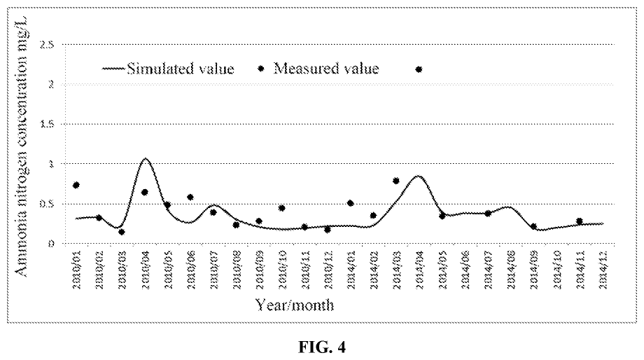

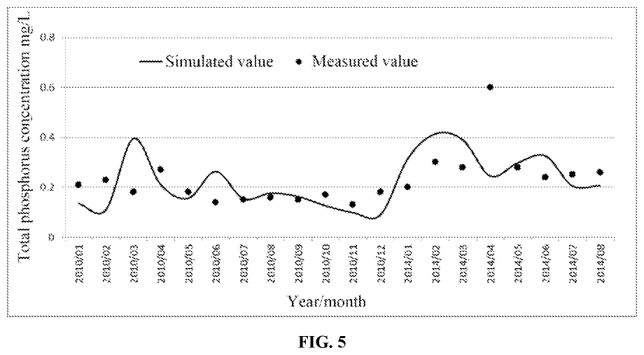

The present disclosure is further described below through specific embodiments and in combination with drawings, and the water resource optimal allocation in Nanliu River basin is taken as an example:
1. Overview of the research region: Nanliu River originates from Darong Mountain, Yulin City, Guangxi, with a total length of 285 km and a whole-basin area of 9,565 km². This basin belongs to the south subtropical monsoon climate and has a rich precipitation therein, with a total mean annual precipitation of 16.5 billion m³, and the regions ahead of Changle have a mean annual runoff of 7.494 billion m³. A large-scale water conservancy project is lacking in Nanliu River basin, the uneven water resource distribution throughout the year, the large population, the large population density, the industrial wastewater, the urban domestic sewage discharge in the basin and the non-point source pollution in the large and medium-sized irrigation zones have aggravated the water pollution situation in the basin, the engineering water shortage and the water quality shortage exist, so it is very necessary to optimize and allocate the water resource in Nanliu River basin.
2. Model construction: the distributed water resource optimal allocation model in Nanliu River basin is constructed for the water resource distribution in Nanliu River basin, characteristics of water conservancy projects and water intake and use situations in each industry. Steps for model construction are as follows: (1) Dividing the allocation units: based on DEM data of Nanliu River basin, the Tangbai River basin is divided into 120 natural sub-basins, and then the land use type map, the soil type map and the slope map are overlaid to be subdivided into 3,235 HRUs. After dividing HRU, the maps of the water resource zoning, the administrative region and the irrigation zone are sequentially overlaid on the GIS map of the HRU by adopting the GIS software, to be divided into 4,178 allocation units. (2) Input of water conservancy project information: mainly including a geographic location, a water passing capacity of a water transportation pipeline, a water-carrying capacity of a diversion canal system, a water diversion/lifting capacity, a water storage capacity of a water intake, a drain outlet, a reservoir, a channel and other water conservancy projects. (3) Input of agricultural management information: including the crop type, planting area, irrigation area, irrigation system of each administrative district and county. (4) Input of allocation rule information: mainly including the water supply source, water source water supply priority, upper limiting concentration of water intake quality, water use priority and other information. (5) Input of meteorological data information: mainly including the precipitation, air temperature, wind speed, radiation, relative humidity data, etc. (6) Input of parameter optimization information: including the optimization parameter, the maximum iteration, etc.
3. Parameter calibration and model verification: performing adaptability checking on Nanliu River basin. The related coefficient and Nash efficiency coefficient are selected to simulate the adaptability evaluation. The comparison result of the simulated result and the measured result of the runoff, ammonia nitrogen and total phosphorus is as shown in FIG. 3, FIG. 4 and FIG. 5, and the simulated value and the measured value of the runoff and the water quality have a better fitting degree.
4. Result analysis: taking the year of 2016 as the base year and in combination with the related planning for economic and social development in Guangxi region, the long-term planning year of 2030 in Nanliu River basin is subjected to the water resource optimal allocation on the basis of forecasting the economic and social development in 2030 and analyzing a plurality of water sources.

The water resource optimal allocation results of Nanliu River basin in 2030 are as shown in Table 1. It can be known from Table 1 that Nanliu River basin has a total water demand of 1.841 billion m³ in 2030, including 438 million m³, 145 million m³ and 1.258 billion m³ in domestic, industrial and agricultural water demand, respectively. The whole basin has a water supply of 1.818 billion m³, a water shortage of 23 million m³ and a basin water shortage rate of 1.3%. At the level of administrative divisions, Yulin City has the maximum water supply, with a total water supply of 1.133 billion m³ and a water shortage of 22.65 million m³, followed by Beihai City, with a water supply of 457 million m³ and a water shortage of 0 billion m³, then Qinzhou City with a minimum water supply of only 227 million m³ and a water shortage of 570,000 m³.

TABLE 1
Statistical Table for Water Supply and Demand Allocation Results in Various
Administrative Regions in Tangbai River Basin in 2030 Level Year

| | | | | | | | Water | Water |
|---|---|---|---|---|---|---|---|---|
| Administrative | | Water demand (10 k m³) | | | | Water | short- | short- |
| region division | | | In- | Agri- | | supply | age | age |
| | County | Domestic | dustrial | cultural | | (10 k | (10 k | rate |
| City | (district) | water | water | water | Total | m³) | m³) | (%) |
| Yulin | Xingye | 2218 | 722 | 7608 | 10548 | 10548 | 0 | 0 |
| City | County | | | | | | | |
| | Beiliu | 3314 | 1444 | 9157 | 13915 | 13915 | 0 | 0 |
| | City | | | | | | | |
| | Yuzhou | 9431 | 4299 | 12466 | 26196 | 26196 | 0 | 0 |
| | District | | | | | | | |
| | Fujin | 3071 | 812 | 15495 | 19378 | 19376 | 2 | 0 |
| | District | | | | | | | |
| | Luzhou | 2767 | 1264 | 7339 | 11370 | 11370 | 0 | 0 |
| | County | | | | | | | |
| | Bobai | 7536 | 2045 | 24613 | 34194 | 31931 | 2263 | 6.6 |
| | County | | | | | | | |
| | Subtotal | 28338 | 10586 | 76677 | 115601 | 113336 | 2265 | 2.0 |
| Beihai | Hepu | 7880 | 1578 | 36274 | 45732 | 45732 | 0 | 0 |
| City | County | | | | | | | |
| | Subtotal | 7880 | 1578 | 36274 | 45732 | 45732 | 0 | 0 |
| Qinzhou | Pubai | 5621 | 1856 | 9749 | 17226 | 17226 | 0 | 0 |
| City | County | | | | | | | |
| | Lingshan | 1915 | 500 | 2972 | 5387 | 5330 | 57 | 1.1 |
| | County | | | | | | | |
| | Qinnan | 63 | 0 | 124 | 187 | 187 | 0 | 0 |
| | District | | | | | | | |
| | Subtotal | 7599 | 2356 | 12845 | 22800 | 22743 | 57 | 0.3 |

| | | | | | | | |
|---|---|---|---|---|---|---|---|
| Total in the basin | 43817 | 14520 | 125796 | 184133 | 181811 | 2322 | 1.3 |

The water consumption and dual water supply situations of each department of each county (region) are as shown in Table 2. Tangbai River basin has a total water demand of 1.818 billion m³ in 2030, including 438 million m³, 145 million m³ and 1.235 billion m³ in domestic, industrial and agricultural water demand, respectively. In each water supply source, the reservoir water supply is the highest (1.066 billion m³), accounting for 58.6% of the total water supply, followed by the river water supply (494 million m³), accounting for 27.2% of the total water supply, the transferred water (130 million m³), accounting for 7.1% of the total water supply, and the reuse water (118 million m³), accounting for 6.5% of the total water supply. The pond water, groundwater and desalination water have less utilization, in which the utilization of the pond water is 8.02 million m³, accounting for 0.44% of the total water supply, the utilization of the groundwater is 1.47 million m³, accounting for 0.08% of the total water supply, and the water supply of the desalination water is minimum (360,000 m³), only accounting for 0.02% of the total water supply.

TABLE 2
Statistical Table for Water Consumption and Supply Allocation Results in Various
Administrative Regions in Nanliu River Basin in 2030 Level Year

| | | Water consumption | | | Water supply (10 k m³) | | | | | | | |
|---|---|---|---|---|---|---|---|---|---|---|---|---|
| Administrative | | (10 k m³) | | | Surface water | | | | | | | |
| region division | | | In- | Agri- | | Reser- | | Trans- | | Re- | Desali- | Total |
| | County | Domestic | dustrial | cultural | River | voir | Pond | ferred | ground- | use | nation | (10 k |
| City | (district) | water | water | water | water | waster | water | water | water | water | water | m³ |
| Yulin | Xingye | 2218 | 722 | 7608 | 1865 | 7987 | 253 | 0 | 40 | 403 | 0 | 10548 |
| City | County | | | | | | | | | | | |
| | Beiliu | 3314 | 1444 | 9157 | 3661 | 6805 | 549 | 1689 | 26 | 1185 | 0 | 13915 |
| | City | | | | | | | | | | | |
| | Yuzhou | 9431 | 4299 | 12466 | 3048 | 8188 | 0 | 10201 | 0 | 4759 | 0 | 26196 |
| | District | | | | | | | | | | | |
| | Fujin | 3071 | 812 | 15492 | 4357 | 13437 | 0 | 1095 | 0 | 486 | 0 | 19375 |
| | District | | | | | | | | | | | |
| | Luzhou | 2767 | 1264 | 7339 | 6415 | 4302 | 0 | 0 | 81 | 572 | 0 | 11370 |
| | County | | | | | | | | | | | |
| | Bobai | 7536 | 2045 | 22350 | 10935 | 19613 | 0 | 0 | 0 | 1383 | 0 | 31931 |
| | County | | | | | | | | | | | |
| | Subtotal | 28337 | 10586 | 74412 | 30281 | 60332 | 802 | 12985 | 147 | 8788 | 0 | 113335 |
| Beihai | Hepu | 7880 | 1578 | 36274 | 8270 | 36456 | 0 | 0 | 0 | 970 | 36 | 45732 |
| City | County | | | | | | | | | | | |
| | Subtotal | 7880 | 1578 | 36274 | 8270 | 36456 | 0 | 0 | 0 | 970 | 36 | 45732 |
| Qinzhou | Pubai | 5621 | 1856 | 9749 | 5598 | 9663 | 0 | 0 | 0 | 1965 | 0 | 17226 |
| City | County | | | | | | | | | | | |
| | Lingshan | 1915 | 500 | 2915 | 5242 | 1 | 0 | 0 | 0 | 87 | 0 | 5330 |
| | County | | | | | | | | | | | |
| | Qinnan | 63 | 0 | 124 | 0 | 179 | 0 | 0 | 0 | 8 | 0 | 187 |
| | District | | | | | | | | | | | |
| | Subtotal | 7599 | 2356 | 12788 | 10840 | 9843 | 0 | 0 | 0 | 2060 | 0 | 22743 |

| | | | | | | | | | | | |
|---|---|---|---|---|---|---|---|---|---|---|---|
| Total in the | 43817 | 14520 | 123474 | 49391 | 106631 | 802 | 12985 | 147 | 11818 | 36 | 181811 |
| basin | | | | | | | | | | | |

The distributed water resource allocation method for overall planning and coordination provided by the present disclosure pays attention to the distributed hydrological model with the physical mechanism and the capability of reflecting the pollutant transporting process, and the hydrological model is combined with the water resource optimal allocation model to achieve bidirectional coupling, learn from others' strong points to offset weakness, give full play to the respective strengths and implement the natural-artificial water cycle process and the accurate simulation for the associated process thereof; and fully considering the coordination among the water quantity and quality, region and unit is the effective path to solve the coordinated allocation issue of the regional water resource. The distributed water resource optimal allocation model can be obtained by applying the distributed water resource allocation method for overall planning and coordination provided by the present disclosure. Based on the allocation relationship and the water demand data, the water resource allocation data can be obtained by the model.

Compared with the existing technology, the present disclosure has the following beneficial effects: (1) the previous water resource allocation model does not fully consider the interactive process of natural-artificial water cycle and water-social economy-environment, and therefore the mutual impact between the water consumption process for human production activities and the natural hydrological process cannot be accurately reflected. The design method for the distributed water resource optimal allocation model for overall planning and coordination proposed by this technology achieves the bidirectional coupling of the water resource optimal allocation model and the distributed hydrological model, processes the water resource optimal allocation function based on the natural-artificial water cycle dynamic mutual feed simulation, and fully considers the interactive process of water-social economy-environment. (2) The previous water resource allocation mainly focuses on the global effect for the optimization of the regional water-social economy-environment system and has insufficient attention to the basic units, such that a disconnecting phenomenon exists in the combination of the actual demands of the water resource allocation and the basic unit, which is hard to meet appeals of individual interests of the basic units. This technology fully considers the implementation effect of the allocation solution based on the satisfaction degree of the basic units to the water resource allocation solution, adopting the distributed water resource allocation method can not only embody the global benefit of the region, but also consider the individual interests of the basic units and improve the satisfaction degree of the basic units to the water resource allocation solution, which facilitate the coordinated and orderly development of the water-social economy-environment system, such that the water resource allocation planning solution is more easily implemented in the specific management.

### Embodiment II

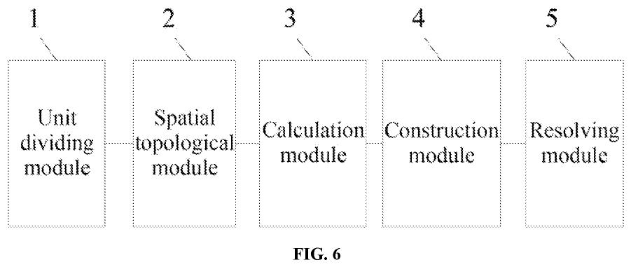

To execute the method corresponding to the foregoing Embodiment I and to implement the corresponding functions and technical effects, a distributed water resource allocation system for overall planning and coordination is provided below, and as shown in FIG. 6, the allocation system includes:

A unit dividing module 1, which is configured to acquire a sub-basin in a setting region based on data of a digital elevation model, and to divide the sub-basin into a plurality of allocation units by applying a multi-attribute overlaying method and according to a land use type, a soil type, a slope type, water resource zoning, an administrative region and an irrigation area.

A spatial topological module 2, which is configured to determine a spatial topological relationship between water users and water sources in the various allocation units according to a water supply priority of the water source and a water use priority of the water user, where the spatial topological relationship is a correspondence between water use types of the water users and water supply types of the water sources, the water use types include urban resident, industry, construction industry, service industry, urban ecological environment, rural resident, livestock breeding, rural ecological environment and agricultural irrigation, and the water supply types include river, reservoir, pond, shallow aquifer, deep aquifer, transferred water, rain collecting pond, water reclamation plants and desalinator.

A calculation module 3, which is configured to acquire water demand data in the administrative region, and to calculate a water supply quantity of each water source as well as a daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user.

A construction module 4, which is configured to construct objective functions and constraint conditions based on the daily water supply of each water source as well as the daily amount of water allocation, water consumption, water discharge and pollutant discharge of each water user, where the objective functions are the maximum regional overall planning and coordination degree and the minimum regional pollutant discharge, and the constraint conditions include a water resource quantity constraint, a total water use quantity constraint, a water supply capacity constraint, a water balance constraint, a dual water supply constraint and a non-negative constraint.

A resolving module 5, which is configured to resolve the objective functions based on the constraint conditions and by adopting a genetic algorithm, to obtain water resource allocation data.

Various embodiments in the specification are described in a progressive manner, each embodiment focuses on the difference from other embodiments, and the same and similar parts of various embodiments can be referred to each other. For the system provided by the embodiment, the system corresponds to the method provided by the embodiment, so the system is simply described, and the related part may refer to the partial description of the method. Specific examples are applied in the present disclosure to set forth the principles and implementations of the present disclosure, and the description of the above embodiment is merely used to help understand the method and its core concept of the present disclosure; at the same time, the concepts of those of ordinary skill in the art based on the present disclosure will be changed in the specific implementations and the application scopes. In conclusion, the contents of the specification shall not be understood as a limitation to the present disclosure.

What is claimed is:

1. A distributed water resource allocation method for overall planning and coordination, wherein the allocation method comprises:
acquiring a sub-basin in a setting region based on data of a digital elevation model, and dividing the sub-basin into a plurality of allocation units by applying a multi-attribute overlaying method and according to a land use type, a soil type, a slope type, water resource zoning, an administrative region and an irrigation zone;
determining a spatial topological relationship between water users and water sources in the various allocation units according to a water supply priority of the water source and a water use priority of the water user, wherein the spatial topological relationship is a correspondence between water use types of the water users and water supply types of the water sources, the water use types of the water users comprise urban resident, industry, construction industry, service industry, urban ecological environment, rural resident, livestock breeding, rural ecological environment and agricultural irrigation, and the water supply types of the water sources comprise river, reservoir, pond, shallow aquifer, deep aquifer, transferred water, rain collecting pond, water reclamation plants and desalinator;
acquiring water demand data in the administrative region, and calculating a water supply amount of each water source as well as a daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user;
constructing objective functions and constraint conditions based on the daily water supply of each water source as well as the daily amount of water allocation, water consumption, water discharge and pollutant discharge of each water user, wherein the objective functions are the maximum regional overall planning and coordination degree and the minimum regional pollutant discharge, and the constraint conditions comprise a water resource quantity constraint, a total water use quantity constraint, a water supply capacity constraint, a water balance constraint, a dual water supply constraint and a non-negative constraint; and
resolving the objective functions based on the constraint conditions and by adopting a genetic algorithm, to obtain water resource allocation data.

2. The distributed water resource allocation method for overall planning and coordination according to claim 1, wherein the multi-attribute overlaying method is a nested allocation units division method.

3. The distributed water resource allocation method for overall planning and coordination according to claim 1, wherein the acquiring the water demand data in the administrative region, and calculating the water supply quantity of each water source as well as the daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user specifically comprises:
acquiring the data of water demand, water consumption rate, urban point source pollution and rural non-point source pollution in the administrative region, wherein the water demand data comprises a water demand for the urban resident, industry, construction industry, service industry, urban ecological environment, rural resident, livestock breeding, rural ecological environment and agricultural irrigation, the urban point source pollution data comprises an urban sewage discharge, an industrial sewage discharge, a sewage treatment rate of a sewage treatment plant, a concentration of a unprocessed sewage and a concentration of a processed sewage, and the rural non-point source pollution data comprises a sewage discharge of the rural life, a sewage discharge of the livestock breeding, a pollutant concentration of the rural resident domestic sewage and a pollutant concentration of the livestock breeding sewage;
determining the daily allocation water and the water demand type of each water user of the allocation unit corresponding to the administrative region as well as the water supply quantity of each water source in the allocation unit corresponding to the administrative region based on the water demand data, the spatial topological relationship, the water supply priority of the water source and the water use priority of the water user, wherein the water demand type comprises water consumption for the rural resident land, urban resident land and irrigation land;
obtaining a water consumption quantity of each water user based on the daily allocation water quantity and the water consumption rate data of each water user;
obtaining a water discharge quantity of each water user based on the daily allocation water quantity and the water consumption quantity of each water user;
calculating an urban point source pollution discharge in the allocation unit corresponding to the administrative region based on the urban point source pollution data;
calculating a rural non-point source pollution discharge in the allocation unit corresponding to the administrative region based on the rural non-point source pollution data;
obtaining the pollution discharge quantity based on the urban point source pollution discharge and the rural non-point source pollution discharge; and
counting the daily water allocation of each water user, the water supply quantity of each water source, the water consumption of each water user and the water discharge and the pollution discharge of each water user in the allocation unit corresponding to the administrative region, and obtaining the water supply quantity of each water source as well as the daily amount of water allocation, water consumption, water discharge and pollutant discharge of each water source in the administrative region.

4. The distributed water resource allocation method for overall planning and coordination according to claim 3, wherein the determining the daily allocation water and the water demand type of each water user of the allocation unit corresponding to the administrative region as well as the water supply quantity of each water source in the allocation unit corresponding to the administrative region based on the water demand data, the spatial topological relationship, the water supply priority of the water source and the water use priority of the water user specifically comprises:
acquiring an urban land area, a rural land area, an agricultural land area, an available water supply and a water use limiting quantity of each water source, and a water intake capacity of a water intake engineering in the administrative region;
obtaining a plurality of urban land allocation units based on the allocation unit with the land use type as the urban land type in the allocation unit corresponding to the administrative region, and obtaining an area of the urban land allocation units based on an urban land area of the urban land allocation units;
obtaining a plurality of rural land allocation units based on the allocation unit with the land use type as the rural land type in the allocation unit corresponding to the administrative region, and obtaining an area of the rural land allocation units based on a rural land area of the rural land allocation units;
obtaining a plurality of agricultural land allocation units based on the allocation unit with the land use type as the agricultural land type in the allocation unit corresponding to the administrative region, and obtaining an area of the agricultural land allocation units based on an agricultural land area of the agricultural land allocation units;
obtaining the urban water demand data of each urban land allocation unit based on a ratio of the area of each urban land allocation unit to the urban land area, wherein the urban water demand data comprises a water demand for the urban resident, industry, construction industry, service industry and urban ecological environment;
obtaining the rural water demand data of each rural land allocation unit based on a ratio of the area of each rural land allocation unit to the rural land area, wherein the rural water demand data comprises a water demand for the rural resident, livestock breeding and rural ecological environment;
obtaining the agricultural water demand data of each agricultural land allocation unit based on a ratio of the area of each agricultural land allocation unit to the agricultural land area, wherein the agricultural water demand data is a water demand for the agricultural irrigation;
determining a target water user of the allocation unit based on the number and the water use priority of the water user in the allocation unit corresponding to the administrative region;
determining a water demand type and water demand data of the target water user based on the land use type of the allocation unit, wherein the water demand data is agricultural water demand data, rural water demand data or urban water demand data;
determining a daily water demand of the target water user based on the water demand data of the target water user;
determining the number, water supply type and water supply priority of each water source corresponding to the target water user in the allocation unit corresponding to the administrative region based on the spatial topological relationship, the water supply priority of the water source and the water demand type;
determining a water intake amount of each water source based on the daily water demand of the target water user, the water supply priority of each water source corresponding to the target water user, the available water supply and the water use limiting quantity of each water source, and the water intake capacity of the water intake engineering; and
determining the daily water allocation of the target water user and the water supply quantity of each water source based on the water intake amount of each water source.

5. The distributed water resource allocation method for overall planning and coordination according to claim 1, wherein the objective functions with the maximum regional overall planning and coordination degree are:
$${F}_{obs 1} = max [ C \cdot S \cdot R \cdot ( 1 - D ) ] ;$$
$${s}_{i} = {\sum }_{i = 1}^{I} {\sum }_{j = 1}^{J} {\sum }_{k = 1}^{K} {WU}_{ijk} / {\sum }_{i = 1}^{I} {\sum }_{j = 1}^{J} {\sum }_{k = 1}^{K} {WD}_{ijk} ;$$
$${r}_{i} = {s}_{i} / {\sum }_{i = 1}^{N} {s}_{i} ;$$
$$C = N \times \sqrt[N]{{\prod }_{i = 1}^{N} {r}_{i}} ;$$
$$S = \frac{1}{N} \times {\sum }_{i = 1}^{N} {s}_{i} ;$$
$$R = \{ \begin{matrix}S & C \geq {C}_{0} \\ S \times \frac{C}{{C}_{0}} & C < {C}_{0}\end{matrix} ;$$
$$D = {\sum }_{i = 1}^{N} \vert {r}_{i} - \frac{1}{N} \vert ;$$
wherein F_{obs1} is an overall planning and coordination degree value, C is a coordination degree of a regional water use system, S is a regional water demand satisfaction, R is a water allocation reasonable degree, D is a difference index of a water demand satisfaction degree, Nis a number of the total allocation units, WUᵢⱼₖ is a water consumption of the j^{th} water user of the i^{th} allocation unit in the k^{th} day; WDᵢⱼₖ is a water demand of the j^{th} water user of the i^{th} allocation unit in the k^{th} day, sᵢ is a satisfaction degree of the actual water consumption of the i^{th} allocation unit in relative to itself water demand; rᵢ is a ratio of the water use satisfaction degree of the i^{th} allocation unit to the water use satisfaction degree of the whole basin system, and C₀ is a coordination standard;
the objective function with the minimum regional pollutant discharge is:
$${F}_{obs 2} = min {\sum }_{i = 1}^{I} {\sum }_{j = 1}^{J} {\sum }_{k = 1}^{K} ( {PT}_{ijk} + {NPT}_{ijk} ) ;$$
wherein F_{obs2} is a total regional pollutant discharge quantity, PTᵢⱼₖ is a discharge quantity of the j^{th} pollutant of the i^{th} allocation unit in the k^{th} day, I is a number of the total allocation units, J is a total number of the pollutants, K is a total number of days, and N is a total number of the configuration units.

6. The distributed water resource allocation method for overall planning and coordination according to claim 1, wherein the water resource quantity constraint is:
$${\sum }_{i = 1}^{9} {WU}_{i} \leq {\sum }_{i = 1}^{3} ( {WS}_{i} \cdot {a}_{i} ) ;$$
$${η}_{Irr , 0} \leq {η}_{Irr} < 1 ;$$
$$0 < {θ}_{pipe} \leq {θ}_{pipe , 0} ;$$
the total water use quantity constraint is:
WU≤min(WUₐᵢₘ,Wᵤₜ);
the water supply capacity constraint is:
W_{supply}=min(Wᵤₜ,W_{cap});
W_{dead}(i)≤V(i)≤V_{MX}(i);
Q(i,j,k)≤Q_{MX}(i);
wherein WUₐᵢₘ is a total annual water consumption target, WU₁ is an urban domestic water consumption, WU₂ is an industrial water consumption, WU₃ is a water consumption for the construction industry, WU₄ is a water consumption for the service industry, WU₅ is a water consumption for the urban ecological environment, WU₆ is a rural domestic water consumption, WU₇ is a water consumption for the livestock breeding, WU₅ is a water consumption for the rural ecological environment, WU₉ is an agricultural irrigation water consumption, WS₁ is an available water for regional storage, WS₂ is a precipitation, WS₃ is transferred water, αᵢ is an effective utilization ratio of the WSᵢ water source, η_{irr,0} is an effective utilization coefficient of the current irrigation water, θ_{pipe,0} is a current pipeline water loss, WU is a total annual water consumption of the region, Wᵤₜ is an annual available water resource of the region, W_{supply} is an available water supply quantity, W_{cap} is an engineering water supply capacity, W_{dead}(i) is a dead storage of a reservoir i, V(i) is a time period storage of the reservoir i, V_{MX}(i) is a maximum storage of the reservoir i, Q(i,j,k) is a water supply supplied to the water user k by the water supply engineering i on the j^{th} day, Q_{MX}(i) is a maximum water diversion/lifting capacity of the water supply engineering i, η_{Irr} is an effective utilization coefficient of the irrigation water, and θₚᵢₚₑ is a pipeline water loss;
the water balance constraint comprises the water balance constraint of the allocation unit and the water balance constraint of the water source, wherein the water balance constraint of the allocation unit is:
$$WF ( i , j , k ) = WD ( i , j , k ) - {WU}_{out} ( i , j , k ) - {WU}_{res} ( i , j , k ) - {WU}_{rch} ( i , j , k ) - {WU}_{shal} ( i , j , k ) - {WU}_{deep} ( i , j , k ) - {WU}_{pnd} ( i , j , k ) - {WU}_{tank} ( i , j , k ) - {WU}_{salt} ( i , j , k ) - {WU}_{re} ( i , j , k ) ;$$
the water balance constraint of the water source is:
$$V ( i , j + 1 ) = V ( i , j ) + {W}_{p} ( i , j ) - {W}_{in} ( i , j ) - {W}_{out} ( i , j ) - WSP ( i , j ) - {W}_{ET} ( i , j ) - {W}_{f} ( i , j ) ;$$
the dual water supply constraint is:
c(k,m)≤min[cu(k),cs(m)];
wherein WF(i,j,k) is a water shortage of the k^{th} water user of the j^{th} allocation unit on the i^{th} day, WD(i,j,k) is a water demand of the k^{th} water user of the j^{th} allocation unit on the i^{th} day, WUₒᵤₜ(i,j,k) is a transferred water supply of the k^{th} water user of the j^{th} allocation unit on the i^{th} day, WUᵣₑₛ(i,j,k) is a reservoir water supply of the k^{th} water user of the j^{th} allocation unit on the i^{th} day, WU_{rch}(i,j,k) is a river water supply of the k^{th} water user of the j^{th} allocation unit on the i^{th} day, WUₛₕₐₗ(i,j,k) is a shallow groundwater supply of the k^{th} water user of the j^{th} allocation unit on the i^{th} day, WU_{deep}(i,j,k) is a deep groundwater supply of the k^{th} water user of the j^{th} allocation unit on the 7th day, WU_{pnd}(i,j,k) is a pond water supply of the k^{th} water user of the j^{th} allocation unit on the i^{th} day, WUₜₐₙₖ(i,j,k) is a rain collecting pond water supply of the k^{th} water user of the j^{th} allocation unit on the i^{th} day, WUₛₐₗₜ(i,j,k) is a desalination water supply of the k^{th} water user of the j^{th} allocation unit on the i^{th} day, WUᵣₑ(i,j,k) is a reuse water supply of the k^{th} water user of the j^{th} allocation unit on the i^{th} day, V (i,j+1) is a water storage amount of the river/reservoir/pond i on the (j+1)^{th} day, V(i,j) is a water storage amount of the river/reservoir/pond i on the j^{th} day, Wₚ(i,j) is a precipitation of the river/reservoir/pond i on the j^{th} day, Wᵢₙ(i,j) is an upstream inflow of the river/reservoir/pond i on the j^{th} day, Wₒᵤₜ(i,j) is an outflow of the river/reservoir/pond i on the j^{th} day, WSP(i,j) is a water supply amount of the river/reservoir/pond i on the j^{th} day, W_{ET}(i,j) is a water surface evaporation of the river/reservoir/pond i on the j^{th} day, Wⱼ(i,j) is a leakage quantity of the river/reservoir/pond i on the j^{th} day, c(k,m) is a water supply concentration supplied to the water user k by the water source m, cu(k) is a maximum water amount concentration capable of being accepted by the water user k, and cs(m) is a target water amount concentration of the water source m.

7. A distributed water resource allocation system for overall planning and coordination, wherein the allocation system comprises:
a unit dividing module, which is configured to acquire a sub-basin in a setting region based on data of a digital elevation model, and to divide the sub-basin into a plurality of allocation units by applying a multi-attribute overlaying method and according to a land use type, a soil type, a slope type, water resource zoning, an administrative region and an irrigation area;
a spatial topological module, which is configured to determine a spatial topological relationship between water users and water sources in the various allocation units according to a water supply priority of the water source and a water use priority of the water user, wherein the spatial topological relationship is a correspondence between water use types of the water users and water supply types of the water sources, the water use types comprise urban resident, industry, construction industry, service industry, urban ecological environment, rural resident, livestock breeding, rural ecological environment and agricultural irrigation, and the water supply types comprise river, reservoir, pond, shallow aquifer, deep aquifer, transferred water, rain collecting pond, water reclamation plants and desalinator;
a calculation module, which is configured to acquire water demand data in the administrative region, and to calculate a water supply quantity of each water source as well as a daily amount of water allocation, water consumption, water discharge and pollutant discharge of each water user in the administrative region according to the spatial topological relationship between the water users and water sources of the allocation unit corresponding to the administrative region, the water supply priority of the water source and the water use priority of the water user;
a construction module, which is configured to construct objective functions and constraint conditions based on the daily water supply of each water source as well as the daily amount of water allocation, water consumption, water discharge and pollutant discharge of each water user, wherein the objective functions are the maximum regional overall planning and coordination degree and the minimum regional pollutant discharge, and the constraint conditions comprise a water resource quantity constraint, a total water use quantity constraint, a water supply capacity constraint, a water balance constraint, a dual water supply constraint and a non-negative constraint; and
a resolving module, which is configured to resolve the objective functions based on the constraint conditions and by adopting a genetic algorithm, to obtain water resource allocation data.
